(19) United States
(12) Patent Application Publication
(10) Pub. No.: US 2024/0142896 A1
(43) Pub. Date: May 2, 2024

(54) SCREW CONVEYING MEMBER, TONER CONTAINER, AND IMAGE FORMING APPARATUS

(71) Applicant: KYOCERA Document Solutions Inc., Osaka (JP)

(72) Inventor: Riku Minamoto, Osaka (JP)

(21) Appl. No.: 18/496,767

(22) Filed: Oct. 27, 2023

(30) Foreign Application Priority Data
Oct. 31, 2022 (JP) 2022-173919

(51) Int. Cl. G03G 15/08

(52) U.S. Cl. CPC G03G 15/0891

(57) ABSTRACT

The screw conveying member that is a resin-molded member, and that conveys toner by rotating. The screw conveying member includes a shaft portion and a blade portion. The blade portion is formed spirally in series on an outer peripheral surface of the shaft portion. The blade portion includes a plurality of unit blade portions each forming one turn in a circumferential direction about a center axis of the shaft portion. In a case where a predetermined integer of 3 or more is taken to be N, each of the plurality of unit blade portions is formed in a same shape in each of N equally divided ranges in the circumferential direction.

### INCORPORATION BY REFERENCE

This application is based upon and claims the benefit of priority from the corresponding Japanese Patent Application No. 2022-173919 filed on Oct. 31, 2022, the entire contents of which are incorporated herein by reference.

### BACKGROUND

The present disclosure relates to a screw conveying member, a toner container, and an image forming apparatus suitable for stably conveying toner.

An image forming apparatus may include a printing portion that executes a printing process using electrophotography. The printing portion executes the printing process using toner. For example, the toner is a powder developing agent.

The image forming apparatus includes a toner container attached to a main body. The toner container includes a storage portion that stores the toner, and a screw conveying member that is arranged in the storage portion.

The screw conveying member has a shaft portion and a blade portion. The blade portion is formed in a spiral shape on an outer peripheral surface of the shaft portion. The screw conveying member, by rotating, stirs the toner and conveys the toner to a feeding port of the storage portion.

### SUMMARY

A screw conveying member according to one aspect of the present disclosure is a molded resin member that conveys toner by rotating. The screw conveying member includes a shaft portion and a blade portion. The blade portion is formed spirally in series on an outer peripheral surface of the shaft portion. The blade portion includes a plurality of unit blade portions each forming one turn in a circumferential direction around a center axis of the shaft portion. In a case where a predetermined integer of 3 or more is taken to be N, each of the plurality of unit blade portions is formed in a same shape in each of N equally divided ranges in the circumferential direction.

A toner container according to another aspect of the present disclosure is attachable to an image forming apparatus. The toner container includes a storage portion and the screw conveying member rotatably arranged in the storage portion and configured to convey the toner.

An image forming apparatus according to another aspect of the present disclosure includes the toner container, and a printing portion configured to form an image on a sheet using the toner fed from the toner container.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an image forming apparatus provided with a screw conveying member according to an embodiment.

FIG. 2 is a perspective view of a toner container provided with a screw conveying member according to an embodiment.

FIG. 3 is a perspective view of a screw conveying member according to an embodiment.

FIG. 4 is a side view of a screw conveying member according to an embodiment.

FIG. 5 is a front view of a screw conveying member according to an embodiment.

FIG. 6 is a view showing a longitudinal section and a transverse section of the screw conveying member according to an embodiment.

FIG. 7 is a configuration diagram of two sets of molds used for manufacturing the screw conveying member according to an embodiment.

FIG. 8 is a perspective view of a screw conveying member according to a reference example.

FIG. 9 is a view showing a longitudinal section and a transverse section of a screw conveying member according to a reference example.

### DETAILED DESCRIPTION

Hereinafter, embodiments according to the present disclosure will be described with reference to the drawings. It should be noted that the following embodiments are examples of embodying the technique according to present disclosure, and do not limit the technical scope of the present disclosure.

[Configuration of Image Forming Apparatus 10]

The image forming apparatus 10 according to an embodiment includes a printing portion 4 that executes a printing process using electrophotography. The printing process is a process for forming an image on the sheet 9. The sheet 9 is an image forming medium such as paper or a sheet-shaped resin member.

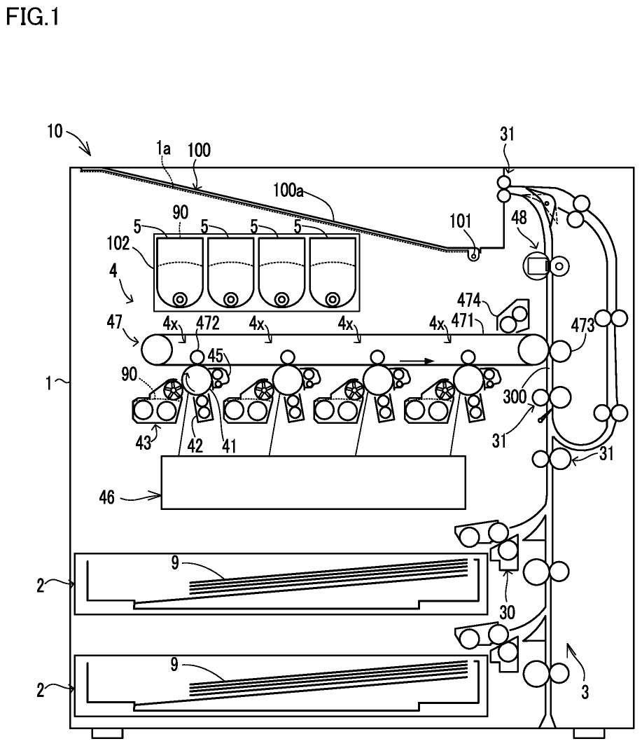

As shown in FIG. 1, the image forming apparatus 10 includes a sheet storing portion 2, a sheet conveying device 3, a printing portion 4, and one or more toner containers 5. In the present embodiment, the image forming apparatus 10 includes a plurality of toner containers 5 corresponding to a plurality of development colors.

The sheet conveying device 3 and the printing portion 4 are arranged inside a main body 1. The plurality of toner containers 5 are each detachably attached to the main body 1. The main body 1 is a main housing of the image forming apparatus 10.

The sheet conveying device 3 includes a sheet feeding device 30 and a plurality of sets of conveying roller pairs 31. The sheet feeding device 30 feeds a sheet 9 stored in the sheet storing portion 2 to a conveying path 300 inside the main body 1.

A plurality of sets of conveying roller pairs 31 convey the sheet 9 along the conveying path 300 and discharge the sheet 9 from an exit portion of the conveying path 300 to a discharge tray 100a.

The printing portion 4 forms an image on the sheet 9 conveyed along the conveying path 300. The printing portion 4 forms an image on the sheet 9 using toner 90 fed from each toner container 5. The printing portion 4 includes one or more image forming portions 4x, an exposure device 46, a transfer device 47 and a fixing device 48.

The image forming portion 4x includes a drum-shaped photoconductor 41, a charging device 42, a developing device 43, a drum cleaning device 45, and the like. In this embodiment, the printing portion 4 includes a plurality of image forming portions 4x corresponding to the plurality of development colors.

In this embodiment, the plurality of development colors are yellow, cyan, magenta and black. Accordingly, the image forming apparatus 10 includes four image forming portions 4x and four toner containers 5.

The transfer device 47 includes an intermediate transfer belt 471, four first transfer portions 472 corresponding to the four image forming portions 4x, a second transfer portion 473, and a belt cleaning portion 474.

In the image forming portion 4x, the photoconductor 41 rotates and the charging device 42 charges a surface of the photoconductor 41. Further, the exposure device 46 writes an electrostatic latent image on the surface of the photoconductor 41.

Further, the developing device 43, by supplying toner 90 to the surface of the photoconductor 41, develops the electrostatic latent image into a toner image. Note that the toner 90 is an example of a powder developing agent.

The transfer device 47 transfers the toner image onto the sheet 9 on the conveying path 300. The first transfer portion 472 transfers the toner image on the surface of the photoconductor 41 to a surface of the intermediate transfer belt 471. Thus, a color toner image is formed on the surface of the intermediate transfer belt 471.

The second transfer portion 473 transfers the toner image formed on the intermediate transfer belt 471 to the sheet 9 on the conveying path 300.

Note that in a case where the image forming apparatus 10 is a monochrome image forming apparatus, the first transfer portion 472 transfers the toner image on the photoconductor 41 to the sheet 9 on the conveying path 300.

The drum cleaning device 45 removes waste toner remaining on the surface of the photoconductor 41. The belt cleaning portion 474 removes waste toner remaining on the intermediate transfer belt 471.

The fixing device 48 fixes the toner image transferred to the sheet 9 to the sheet 9 by applying heat and pressure.

Each toner container 5 is a unit that stores toner 90. Each toner container 5 is a consumable item that can be attached to and detached from the main body 1. Each toner container 5 feeds toner 90 to a toner supply path communicating with each developing device 43.

The image forming apparatus 10 further includes an attachment portion 102 to which the toner container 5 is attached. Each toner container 5 is detachably attached to the attachment portion 102 provided inside the main body 1. The main body 1 is formed with a main opening 1a communicating with the attachment portion 102.

In the present embodiment, the main opening 1a is formed in an upper portion of the main body 1. The image forming apparatus 10 further includes a cover portion 100 that closes the main opening 1a. In the present embodiment, the cover portion 100 forms a discharge tray 100a.

The cover portion 100 is able to open and close the main opening 1a. The toner container 5 is replaced in a state in which the cover portion 100 is opened.

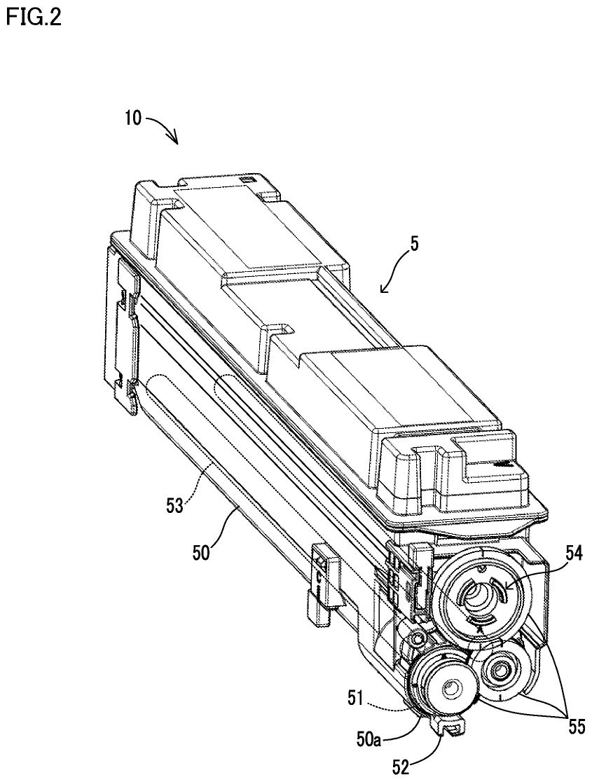

As shown in FIG. 2, the toner container 5 includes a storage portion 50, a shutter 51, a shutter input portion 52, a screw conveying member 53, a rotation input portion 54, and a gear mechanism 55. The storage portion 50 is a container that stores the toner 90. The shutter 51 is a member that closes the feeding port 50a for the toner 90.

The feeding port 50a is an opening formed in the storage portion 50. The feeding port 50a is formed in the toner container 5 at a lower portion of an end portion in the longitudinal direction.

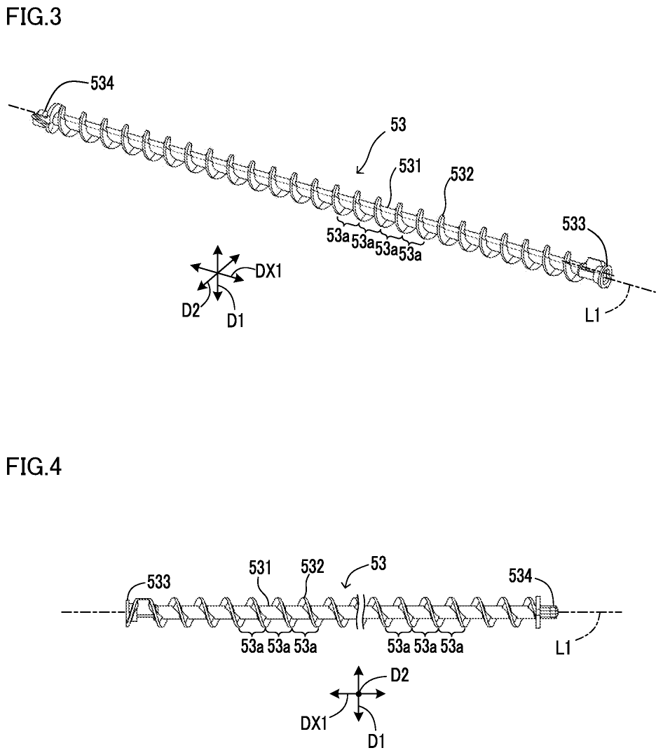

The screw conveying member 53 is rotatably arranged in the storage portion 50. The screw conveying member 53 has a shaft portion 531, a blade portion 532, a first end portion 533 and a second end portion 534 (see FIGS. 3 and 4).

The shaft portion 531 is columnar or cylindrical. In the present embodiment, the shaft portion 531 is columnar. Hereinafter, a direction along a center axis L1 of the shaft portion 531 is referred to as an axial direction DX1 (see FIGS. 3 and 4). The axial direction DX1 is the longitudinal direction of the screw conveying member 53.

The blade portion 532 is formed spirally in series on an outer peripheral surface of the shaft portion 531. The blade portion 532 protrudes from the outer peripheral surface of the shaft portion 531.

The first end portion 533 is formed at one end portion of the shaft portion 531 and the second end portion 534 is formed at an other end portion of the shaft portion 531. The first end portion 533 and the second end portion 534 are each rotatably supported by the storage portion 50.

The screw conveying member 53 conveys the toner 90 in the storage portion 50 to the feeding port 50a by rotating. The toner 90 in the storage portion 50 is conveyed by the screw conveying member 53 and is fed from the feeding port 50a.

The shutter 51 is attached to the storage portion 50 so as to be capable of opening and closing the feeding port 50a. The shutter input portion 52 displaces by receiving an external force for opening and closing the shutter 51.

The shutter 51 opens when the shutter input portion 52 receives an external force and displaces in an opening direction. On the other hand, the shutter 51 closes when the shutter input portion 52 receives an external force and displaces in a closing direction.

The shutter input portion 52 engages with a shutter output portion (not shown) provided on the attachment portion 102. The shutter output portion displaces in conjunction with the opening and closing operation of the cover portion 100.

When the cover portion 100 is opened, the shutter input portion 52 closes in conjunction with the displacement of the shutter output portion. When the cover portion 100 is closed, the shutter input portion 52 opens in conjunction with the displacement of the shutter output portion.

The screw conveying member 53 is rotatably arranged in the storage portion 50. The rotation input portion 54 receives an external force that rotates the screw conveying member 53. The screw conveying member 53 stirs and conveys the toner 90 in the storage portion 50 by rotating.

The rotation input portion 54 engages with a rotation output portion (not shown) provided on the attachment portion 102. The rotation output portion rotates by being driven by a motor (not shown). The rotation output portion transmits a rotational force to the rotation input portion 54.

The gear mechanism 55 transmits a rotational force from the rotation input portion 54 to the first end portion 533 of the screw conveying member 53. By the rotation input portion 54 being driven, the screw conveying member 53 rotates in conjunction with the rotation input portion 54.

The screw conveying member 53 is normally a molded resin member. In the present embodiment as well, the screw conveying member 53 is a molded resin member. For example, the screw conveying member 53 is a molded member made of thermoplastic resin having a main component of polypropylene, polyethylene, polyvinyl chloride, polyethylene terephthalate, polyamide, or the like.

A conventional screw member is often molded by a pair of molds arranged facing each other. In this case, a variation in thickness in the circumferential direction of the blade portion of the screw member increases.

On the other hand, in the image forming apparatus 10, it is desirable that the screw conveying member 53 be able to convey the toner 90 more stably. The screw conveying member 53 is able to convey the toner 90 more stably the smaller the variation in the thickness in the circumferential direction of the blade portion 532 is.

The screw conveying member 53 has a structure for enabling stable conveying of the toner 90. The structure of the screw conveying member 53 will be described below.

[Structure of Screw Conveying Member 53]

The blade portion 532 includes a plurality of unit blade portions 53a each forming one turn in the circumferential direction around the center axis L1 (see FIGS. 3 and 4).

In the following description, two directions, which are diametrical directions of the shaft portion 531, are referred to as a first direction D1 and a second direction D2 (see FIGS. 3 to 5). The first direction D1 and the second direction D2 are directions that divide the circumferential direction into four equal parts.

The circumference of the shaft portion 531 is divided into four equally divided ranges A1 to A4 by a first plane F1 along the first direction D1 and a second plane F2 along the second direction D2 (see FIG. 5) The first plane F1 and the second plane F2 are two planes each including the center axis L1 and equally dividing the circumferential direction about the center axis L1 into four ranges.

Each of the plurality of unit blade portions 53a is formed in the same shape in each of the four equally divided ranges A1 to A4 in the circumferential direction. This structure is hereinafter referred to as a first characteristic structure of the screw conveying member 53.

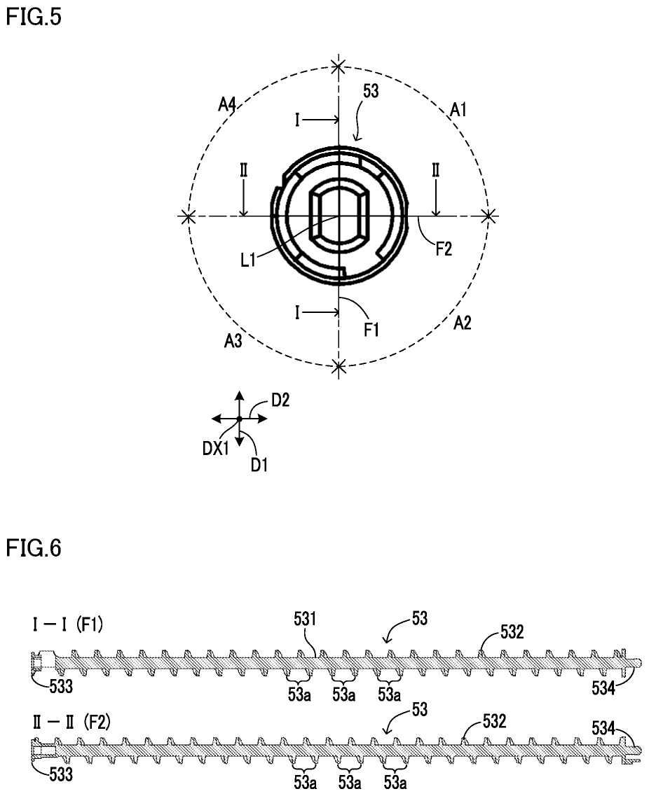

In FIG. 5, the I-I plane is the first plane F1 and the II-II plane is the second plane F2. FIG. 6 shows cross sections of the screw conveying member 53 in a case where the first plane F1 is a cutting plane and in a case where the second plane F2 is a cutting plane.

As shown in FIG. 6, the two types of cross-sectional shapes of the blade portion 532 are the same when the first plane F1 and the second plane F2 are taken as cutting planes. This structure is hereinafter referred to as a second characteristic structure of the screw conveying member 53.

Note that in a case where a plane passing through the center axis L1 is a cutting plane, the cross-sectional shape of the blade portion 532 is trapezoidal regardless of a direction of the cutting plane.

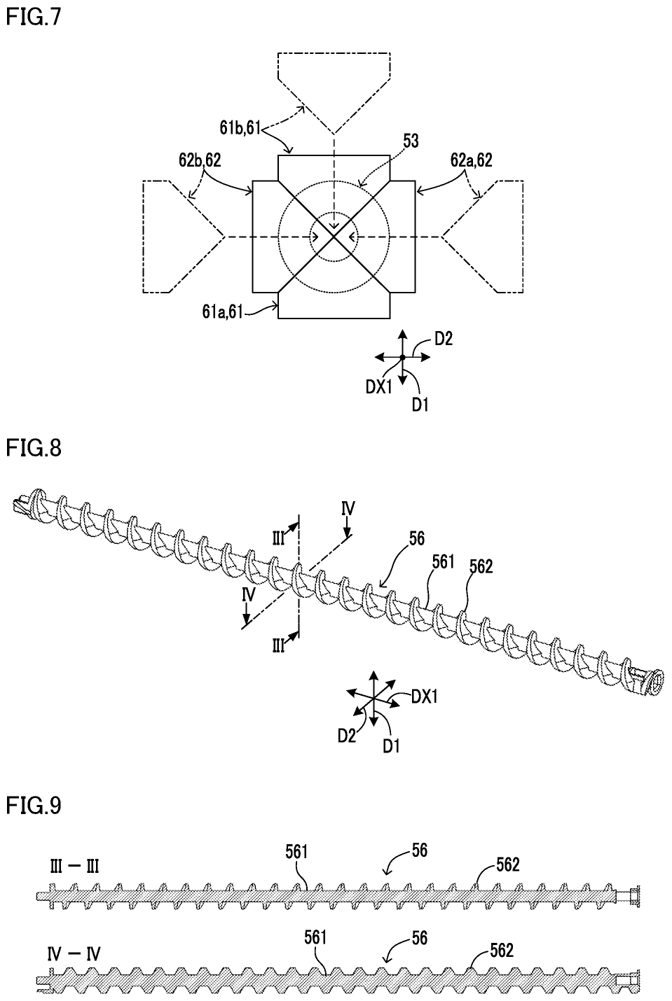

FIG. 7 shows two sets of mold pairs used for molding the screw conveying member 53. The two sets of mold pairs include a first mold pair 61 and a second mold pair 62.

The first mold pair 61 includes a first cavity member 61a and a first core member 61b arranged facing each other along the first direction D1. The second mold pair 62 includes a second cavity member 62a and a second core member 62b arranged facing each other along the second direction D2.

The first characteristic structure and the second characteristic structure of the screw conveying member 53 are achieved by molding with the first mold pair 61 and the second mold pair 62.

### Reference Example

FIGS. 8 and 9 show a screw conveying member 56 according to a reference example. The screw conveying member 56 can be applied to the image forming apparatus 10 instead of the screw conveying member 53.

The screw conveying member 56 has a shaft portion 561 and a blade portion 562. The blade portion 562 is formed in a spiral shape on an outer peripheral surface of the shaft portion 561.

The screw conveying member 56 is molded by a pair of molds arranged facing each other along the first direction D1.

In FIGS. 8 and 9, the first direction D1 and the second direction D2 are each diametrical directions of the shaft portion 561. The first direction D1 and the second direction D2 are orthogonal.

In FIGS. 8 and 9, the III-III plane is a plane that includes the center axis of the shaft portion 561 and extends along the first direction D1. In FIGS. 8 and 9, the IV-IV plane is a plane that includes the center axis of the shaft portion 561 and extends along the second direction D2.

As shown in FIG. 9, when the III-III plane and the IV-IV plane are taken to be cutting planes, the two types of cross-sectional shapes of the blade portion 562 are different. Since the screw conveying member 56 is molded by the pair of molds, the thickness of the blade portion 562 varies greatly in the circumferential direction.

On the other hand, the thickness of the blade portion 532 of the screw conveying member 53 is generally uniform in the circumferential direction. Therefore, the screw conveying member 53 is able to stably convey the toner 90.

### Application Example

An application example of the screw conveying member 53 will be described below. Hereinafter, the screw conveying member according to the application example will be referred to as a specific conveying member.

The specific conveying member also has a shaft portion 531 and a blade portion 532 similar to the screw conveying member 53. In addition, the blade portion 532 of the specific conveying member also includes a plurality of unit blade portions 53a.

Here, N is taken to be a predetermined integer of 3 or more. In the specific conveying member, each of the plurality of unit blade portions 53a is formed in the same shape in each of N equally divided ranges in the circumferential direction.

In this application example, N is preferably an even number of 4 or more. Here, M is taken to be an integer that is half of N. In a case where N is an even number of 4 or more, the specific conveying member is molded by M sets of mold pairs.

In addition, in a case where N is an even number of 4 or more and M is an integer that is half of N, the specific conveying member has the following structure. That is, when M planes, each including the center axis L1 of the shaft portion 531 and equally dividing the circumferential direction centered on the center axis L1 into N ranges, are used as the cutting planes, the M types of cross-sectional shapes of the blade portion 532 of the specific conveying member are the same.

Even in a case where the specific conveying member is employed, similar effects as in a case where the screw conveying member 53 is employed can be obtained. Note that the specific conveying member in a case where N is 4 is the screw conveying member 53.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A screw conveying member that is a resin-molded member and that conveys toner by rotating; the screw conveying member comprising:
a shaft portion; and
a blade portion spirally formed in series on an outer peripheral surface of the shaft portion; wherein
the blade portion includes a plurality of unit blade portions each forming one turn in a circumferential direction about a center axis of the shaft portion; and
in a case where a predetermined integer of 3 or more is taken to be N, each of the plurality of unit blade portions is formed in a same shape in each of N equally divided ranges in the circumferential direction.

2. The screw conveying member according to claim 1, wherein N is an even number of 4 or more.

3. A screw conveying member that is a resin-molded member and that conveys toner by rotating; the screw conveying member comprising:
a shaft portion; and
a blade portion spirally formed in series on an outer peripheral surface of the shaft portion; wherein
in a case where a predetermined integer of 4 or more is taken to be N, and an integer half of N is taken to be M, when M planes each including a center axis of the shaft portion and equally dividing a circumferential direction centered on the center axis into N ranges are used as cutting planes, M types of cross-sectional shapes of the blade portion are the same.

4. A toner container that is attachable to an image forming apparatus; the toner container comprising:
a storage portion configured to store toner and including a feeding port for the toner; and
a screw conveying member according to claim 1 that is rotatably arranged in the storage portion and configured to convey the toner.

5. An image forming apparatus, comprising:
the toner container according to claim 4; and
a printing portion configured to form an image on a sheet using toner fed from the toner container.
